(19) United States
(12) Patent Application Publication
(10) Pub. No.: US 2024/0010848 A1
(43) Pub. Date: Jan. 11, 2024

(54) SELF-CLEANING EXTERNAL LAYER COMPRISING A SELF-CLEANING AERODYNAMIC SURFACE, AND VEHICLE COMPRISING SAID EXTERNAL LAYER

(71) Applicant: Airbus Operations SAS, TOULOUSE (FR)

(72) Inventors: François PONS, TOULOUSE (FR); Franck DOBIGEON, TOULOUSE (FR); Cédric LOUBAT, TOULOUSE (FR); Agathe BOUVET-MARCHAND, TOULOUSE (FR); Julien GARCIA, TOULOUSE (FR)

(21) Appl. No.: 18/249,348

(22) PCT Filed: Oct. 18, 2021
(86) PCT No.: PCT/EP2021/078789

§ 371 Date: Apr. 17, 2023

(30) Foreign Application Priority Data
Oct. 19, 2020 (FR) 2010683

(51) Int. Cl. C09D 5/16; B64C 7/02; B64D 33/02

(52) U.S. Cl. CPC C09D 5/1687; B64C 7/02; B64D 33/02; C09D 5/1675; B64C 2230/26

(57) ABSTRACT

A self-cleaning external with a self-cleaning aerodynamic surface configured to extract at least some of the oxygen present in the atmosphere in contact with the aerodynamic surface so as to at least partially deprive a haemolymph of the insect residue, present on the aerodynamic surface after being hit by insects, of oxygen. Also, a vehicle with at least one such self-cleaning aerodynamic surface.

### RELATED APPLICATIONS

This application is a national phase of International Application No. PCT/EP2021/078789 filed on Oct. 18, 2021, which claims priority to French Patent Application No. 2010683 filed on Oct. 19, 2020, the entire disclosures of which are incorporated herein.

### FIELD OF THE INVENTION

The present application relates to a self-cleaning external layer having a self-cleaning aerodynamic surface and to a vehicle comprising said external layer.

### BACKGROUND OF THE INVENTION

During the phases of taxiing, takeoff and landing, the aerodynamic surfaces of an aircraft may be struck by insects. The insect residue adhering to an aerodynamic surface disrupts the flow of air in contact with this surface, and leads to an increase in the drag and fuel consumption of the aircraft. As a result, this fouling has to be cleaned off regularly. Now, this insect residue has a tendency to adhere firmly to the surface, making it difficult to remove.

According to an embodiment described in document US2019177572, an antifouling coating contains two components, a first component reducing the surface energy and a hygroscopic second component that reduces the coefficient of friction. This solution encourages the insect residue to slide off.

According to other embodiments, an antifouling coating is made from a superhydrophobic material, such as described in the publication “Influence of surface characteristics on insect residue adhesion to aircraft leading edge surfaces”, PROGRESS IN ORGANIC COATINGS, vol. 76, No. 11, November 2013, or in document FR2954340 for example.

The performance of these coatings is not optimal and traces of insects on the surface remain.

### SUMMARY OF THE INVENTION

The present invention proposes a different approach that can be substituted for, or used to enhance, the existing solutions.

To that end, one subject of the invention is a self-cleaning external layer comprising a surface intended to be in contact with an atmosphere and against which an air stream flows during operation, forming an aerodynamic surface, characterized in that the external layer is made from a material containing at least an oxygen-absorbing additive in order to extract at least some of the oxygen present in the atmosphere in order to at least partially deprive of oxygen the hemolymph of insect residue in contact with said aerodynamic surface following insect strike.

Thus, the hemolymph in the insect residue remains in a liquid or pasty state for longer, making it easier for the insect residue to be detached from the aerodynamic surface. This property of the external layer, combined with the action of a stream of air flowing in contact with the aerodynamic surface, makes it possible to obtain an aerodynamic surface that is self-cleaning.

According to other features considered in isolation or in combination:
the oxygen-absorbing additive is iron-based;
the material of the external layer contains at least 0.2 wt % of iron particles;
the material of the external layer contains less than 10 wt % of iron particles;
the material of the external layer contains at least an activator configured to give the oxygen-absorbing additive an oxygen-absorbing effect over the widest possible percentage-humidity range;
the activator is selected from an alkali-metal halide or sodium chloride;
the material of the external layer contains at least 0.2 wt % silicone;
the weight content of the silicone is less than or equal to 10% and preferably less than 5%;
the external layer is made from a material selected from materials based on superhydrophobic, oleophobic or omniphobic polymers, on hydrophilic polymers, on polytetrafluoroethylene, on fluorinated polyurethane, on polysilazane, or materials of the SLIPS or sol-gel type, containing at least an oxygen-absorbing additive;
the material of the external layer contains at least a fluorinated compound;
the external layer has a thickness greater than 20 μm;
the external layer is made from a material having a hardness that encourages the insect residue to bounce off.

Another subject of the invention is a vehicle comprising at least an external layer according to one of the above features.

According to another feature, the vehicle is configured in such a way that an air stream having a velocity in excess of 30 m/s flows against the aerodynamic surface.

Finally, another subject of the invention is an aircraft air intake comprising at least an external layer according to one of the preceding features.

### BRIEF DESCRIPTION OF THE DRAWINGS

Further features and advantages will become apparent from the following description of the invention, which description is given purely by way of example, and with reference to the attached drawings in which:

FIG. 1 is a perspective view of an aircraft incorporating an enlarged perspective view of an air intake,

FIG. 2 is a cross section through an external layer having an aerodynamic surface subjected to an air stream indicated by an arrow illustrating a first configuration of the invention, and

FIG. 3 is a cross section of an external layer comprising an aerodynamic surface subjected to an air stream indicated by an arrow illustrating one embodiment of the invention,

FIG. 4 is a perspective view of an aluminum alloy plate following an insect strike,

FIG. 5 is a perspective view of the plate visible in FIG. 4 following cleaning by a blast of air,

FIG. 6 is a perspective view of an aluminum alloy plate with a filler-free hydrophobic coating following an insect strike,

FIG. 7 is a perspective view of the plate visible in FIG. 6, after cleaning by blowing with air,

FIG. 8 is a perspective view of an aluminum alloy plate comprising a hydrophobic coating with iron particles following an insect strike, and

FIG. 9 is a perspective view of the plate visible in FIG. 8 following cleaning by blowing with air.

### DETAILED DESCRIPTION

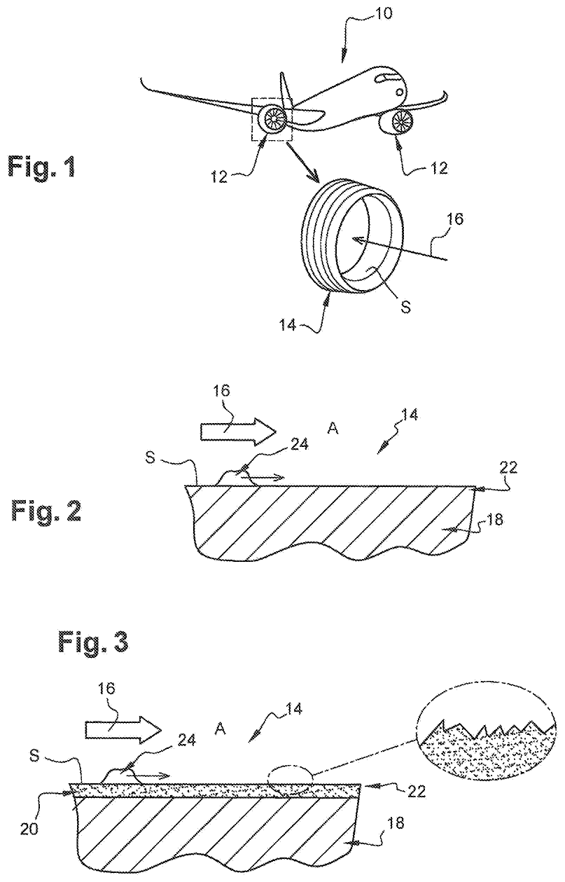

In FIG. 1, an aircraft 10 comprises a number of propulsion units 12 each having a turbojet engine and an air intake 14 positioned in front of the turbojet engine and able to duct an air stream towards the engine. The invention is not in any way limited to this application.

As illustrated in FIGS. 2 and 3, this air intake 14 comprises at least an aerodynamic surface S over which an air stream 16 flows.

In the case of an aircraft 10, the air stream 16 needs to be disturbed as little as possible and remain laminar for as long as possible in contact with the aerodynamic surface S.

In a first configuration visible in FIG. 2, a component 18 is made from a single material and has no coating. This component 18 comprises a surface against which an air stream 16 flows and forming the aerodynamic surface S.

In a second configuration visible in FIG. 3, a component 18 comprises a coating 20 which has a surface against which an air stream 16 flows and which forms the aerodynamic surface S, the component 18 being made from a first material and the coating from a second material.

Whatever the configuration, the component 18 comprises an external layer 22 (part of the component 18, the coating 20 of the component 18 or part of the coating 20 of the component 18) which has a surface in contact with an atmosphere A, against which an air stream 16 flows during operation and which forms the aerodynamic surface S and is self-cleaning and made from a self-cleaning material.

During the takeoff, landing and/or taxiing phases, insects strike the aerodynamic surface S and generate insect residue 24 on the aerodynamic surface S.

This insect residue 24 is essentially made up of hemolymph. The hemolymph is in liquid state at the moment of impact or shortly thereafter and fairly soon after impact the hemolymph of the insect residue 24 changes phase and hardens upon contact with oxygen, causing the insect residue 24 to adhere more strongly to the aerodynamic surface S. Following this change in phase, it therefore becomes very difficult to detach the insect residue 24 from the aerodynamic surface S.

According to one feature of the invention, in order to slow or prevent the change in phase of the hemolymph of the insect residue 24, the external layer 22 is configured to extract at least some of the oxygen present in the atmosphere A in sufficient quantity to at least partially deprive of oxygen the hemolymph of the insect residue 24 which hemolymph remains in a liquid or pasty state for longer, making it easier for the insect residue 24 to be detached from the aerodynamic surface S by the air stream 16 flowing in contact with the aerodynamic surface S.

To this end, the external layer 22 is made of a material containing at least an oxygen-absorbing additive.

This property of the external layer 22, combined with the action of the air stream 16 flowing in contact with the aerodynamic surface S, makes it possible to obtain an aerodynamic surface S that is self-cleaning. In order to obtain this self-cleaning effect, the air stream needs to have a certain velocity, greater than 30 m/s.

The invention is more particularly suited to the aerodynamic surfaces of a vehicle and notably to those of an aircraft. Thus, the aerodynamic surfaces S of an aircraft, such as the air intakes 14 and the leading edges for example, struck by insects during taxiing and takeoff, self-clean such that in the cruising phase, the disturbances to the air streams flowing in contact with these aerodynamic surfaces S are limited, this tending to reduce the drag and fuel consumption of the aircraft.

Of course, the invention is not restricted to these surfaces. By way of indication, a windshield may comprise a coating 20 forming an external layer 22 made of a material containing at least an oxygen-absorbing additive.

According to one embodiment, the external layer 22 has a thickness greater than or equal to 1 μm.

According to one configuration, the external layer 22 has a thickness greater than 20 μm so that its capacity to extract oxygen from the atmosphere A is of sufficiently long duration, of several years. According to one embodiment, the external layer 22 has a thickness of between 20 and 100 μm.

According to one configuration, the material of the external layer 22 has a hardness suited to encouraging the insect residue 24 to bounce off. To that end, the hardness obtained in terms of “pencil hardness” is comprised between 4B and 9H for an FPU-based (fluorinated polyurethane-based) or PUH-based (polyurethane hybrid-based) material, preferably comprised between HB and 9H, and comprised between 3H and 9H for a polysilazane-based material, preferably of the order of 6H. Thus, this property of the self-cleaning material, combined with the velocity and/or the flow rate of the stream of air in contact with the aerodynamic surface S, encourages the insect residue 24 to bounce off at the moment of impact, limiting the stagnation of the insect residue 24 on the aerodynamic surface S.

According to one configuration, the aerodynamic surface S has a smooth surface finish.

This property of the aerodynamic surface S, combined with the velocity and/or the flow rate of the air stream 16 in contact with the aerodynamic surface S, encourages the detachment of the insects.

According to another feature, in order to encourage slip, the aerodynamic surface of the external layer 22 has low surface energy of below 25 mN/m, with a dispersive component that is markedly higher than the polar component.

To complement this, since the insect residue 24 in the liquid phase is of the lipid type, the material of the external layer 22 is oleophobic in order to encourage said insect residue 24 to slip over the aerodynamic surface S and separate from said surface. More generally, the material of the external layer 22 is omniphobic.

The material of the external layer 22, that gives the aerodynamic surface S a self-cleaning capacity, may be selected from among the existing materials that encourage insect residue to slip, such as materials based on superhydrophobic, oleophobic or omniphobic polymers, on hydrophilic polymers, on polytetrafluoroethylene, on fluorinated polyurethane, on polysilazane or materials of the SLIPS or sol-gel type, which are modified in such a way that they extract the oxygen from the atmosphere A in contact with the aerodynamic surface S. Thus, it is possible to enhance the self-cleaning capacity of the aerodynamic surface S by combining its capacity to encourage slip with that of fixing the oxygen present in the atmosphere A to the detriment of the insect residue 24 which thus does not harden as quickly.

According to the invention, the material of the external layer 22 contains at least an additive capable of capturing or extracting the oxygen present in the atmosphere A in contact with the aerodynamic surface S.

For the purposes of the present application what is meant by an additive is fillers, organic molecules, particles of any size such as particles, microparticles, nanoparticles or the like.

According to one configuration, the additive takes the form of fillers, of particles of all sizes configured to migrate in the material.

According to one configuration, the additive capable of extracting the oxygen is dispersed in a polymer matrix.

According to one embodiment, the oxygen-absorbing additive is metallic, such as iron powder, activated iron powder or an iron salt for example.

According to another embodiment, the oxygen-absorbing additive is an organic compound such as ascorbic acid, for example an ascorbic acid salt.

According to another embodiment, the oxygen-absorbing additive is an inorganic compound such as a sulfite or thiosulfate.

Of course, these lists are not exhaustive and other oxygen-absorbing additives could be used.

In a preferred embodiment, the oxygen-absorbing additive is iron or iron-based, such as iron powder for example. The material of the external layer 22 contains at least 0.2 wt % of iron particles. According to one configuration, the weight content of the iron particles is less than or equal to 10% and preferably less than 5%.

According to one embodiment, the material of the external layer 22 contains at least an activator configured to give the oxygen-absorbing additive an oxygen-absorbing effect over the broadest possible percentage-humidity range. In the case of iron, the activator may be an alkali-metal halide, for example sodium chloride. Of course, this list of activators is not exhaustive. According to one configuration, the material of the external layer 22 contains at least 0.2 wt % of activator. The weight content of the activator is less than or equal to 10% and preferably less than 5%.

According to one configuration, the material of the external layer 22 contains a polyurethane resin obtained from at least an isocyanate and at least a polyol. This polyurethane resin is selected according to the desired chemical and mechanical properties. Thus, it is selected so that it has excellent adhesion to its support, excellent resistance to environmental influences (temperature, corrosion, UV radiation, etc.), the desired hardness, and excellent impact strength.

According to a first example, the material of the external layer 22 is obtained from the following composition containing:
at least a polyol component having on average at least two hydroxyl groups per molecule,
at least an isocyanate component having on average at least two isocyanate groups per molecule,
at least a solvent.

The composition generally contains at least a catalyst.

According to one configuration, the composition contains:
between 30 and 60 wt %, preferably between 40 and 45 wt %, of at least a polyol component having on average at least two hydroxyl groups per molecule,
between 5 and 20 wt %, preferably between 10 and 15 wt %, of at least an isocyanate component having on average at least two isocyanate groups per molecule,
between 30 and 60 wt %, preferably between 30 and 45 wt %, of at least a solvent,
between 0 and 5 wt % of at least a catalyst.

This composition contains between 0.2 and 5% iron particles to capture the oxygen.

The polyol component is a perfluorovinylether of the FEVE type containing an alternating sequence of fluoroethylene molecules and of alkylvinylether molecules:

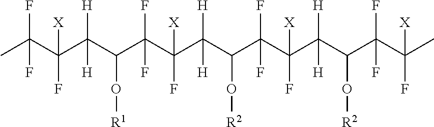

R being a functional group derived from hydroxybutylvinylether, hydroxyethylvinylether, butylvinylether, ethylvinylether, etc.

X being either H or F.

By way of example and nonlimitingly, the perfluorovinylether of FEVE type corresponds to the product marketed under the trade name “Lumiflon LF 910LM”.

Other polyols may be used to replace the perfluorovinylether or as additives from among polyethers, poly(vinylethers), acrylics, polyesters, polyamides, polyacrylates and polycarbonates having the required level of hydroxyl groups; polyethers, poly(vinylethers), acrylics and polyesters being preferred.

In certain instances, the polyol component is a fluorinated polyol, preferably a perfluorinated polyol such as perfluorinated polyethers, perfluorinated poly(vinylethers) for example.

In certain instances, the polyol component is an aliphatic polyol, preferably an acrylic polyol. Aliphatic polyols make it possible to achieve a good compromise between good resistance to environmental influences, good chemical resistance, good impact strength, good adhesion to the support and desired hardness.

Additives having only a single hydroxyl group may also be introduced. For example, hydroxyl-terminated fluorinated molecules. Additives having several hydroxyl groups may be introduced.

According to one embodiment, the isocyanate component is a polyisocyanate such as an aliphatic isocyanate prepolymer based on hexamethylene diisocyanate (HDI) and/or on isophorone diisocyanate (IPDI). By way of example and nonlimitingly, the hexamethylene diisocyanate corresponds to the product marketed under the trade name “Desmodur ultra N3300” or “Desmodur ultra N3400”.

Other isocyanate components could be used, such as aromatic isocyanates, although aliphatic isocyanates are preferred on account of their better UV resistance.

According to one embodiment, the solvent is an organic solvent selected from ketones, acetates, aromatic hydrocarbons (toluene, paraxylene), etc.

By way of example, the catalyst is dibutyltin dilaurate, abbreviated to DBTDL.

According to one procedure, the polyol component is diluted in the solvent in order to adjust the viscosity of the composition. Next, the isocyanate component is introduced and this mixture is stirred to render it homogenous. Finally, the catalyst is introduced and the mixture is stirred again in order to homogenize it.

According to a second example, the material of the external layer 22 is obtained from the following composition containing:
at least a polyol component having on average at least two hydroxyl groups per molecule,
at least an isocyanate component having on average at least two isocyanate groups per molecule,
at least a solvent.

The composition may contain at least a catalyst, at least an anti-contaminant additive and/or anti-contaminant particles, at least a hydrophobic additive and/or hydrophobic particles, at least a surface additive.

According to one configuration, the composition contains:
between 30 and 60 wt %, preferably between 35 and 45 wt %, of at least a polyol component having on average at least two hydroxyl groups per molecule,
between 5 and 20 wt %, preferably between 8 and 15 wt %, of at least an isocyanate component having on average at least two isocyanate groups per molecule,
between 30 and 60 wt %, preferably between 30 and 45 wt %, of at least a solvent,
between 0 and 5 wt % of at least a catalyst,
between 0 and 15 wt % of at least a hydrophobic additive and/or of hydrophobic particles,
between 0 and 10 wt % of at least a surface additive,
between 0 and 5 wt % of at least an adhesion promoting additive.

This composition contains between 0.2 and 5% of iron particles for capturing the oxygen.

The polyol component is a perfluorovinylether of FEVE type containing an alternating sequence of fluoroethylene molecules and of alkylvinylether molecules. By way of example and nonlimitingly, the perfluorovinylether of FEVE type corresponds to the product marketed under the trade name “Lumiflon LF 910LM”.

Other polyols may be used as a replacement for the perfluorovinylether or as additives from among polyethers, poly(vinylethers), acrylics, polyesters, polyamides, polyacrylates and polycarbonates having the required level of hydroxyl groups; polyethers, poly(vinylethers), acrylics and polyesters being preferred.

In certain instances, the polyol component is a fluorinated polyol, preferably a perfluorinated polyol such as perfluorinated polyethers, for example perfluorinated poly(vinylethers).

In certain instances, the polyol component is an aliphatic polyol, preferably an acrylic polyol. Aliphatic polyols make it possible to achieve a good compromise between good resistance to environmental influences, good chemical resistance, good impact strength, good adhesion to the support and the desired hardness.

According to one embodiment, the isocyanate component is a polyisocyanate such as an aliphatic isocyanate prepolymer based on hexamethylene diisocyanate (HDI) and/or on isophorone diisocyanate (IPDI). By way of example and nonlimitingly, the hexamethylene diisocyanate corresponds to the product marketed under the trade name “Desmodur ultra N3300” or “Desmodur ultra N3400”.

Other isocyanate components could be used, such as aromatic isocyanates. Aliphatic isocyanates are preferred on account of their better UV resistance.

According to one embodiment, the solvent is an organic solvent selected from ketones, acetates, aromatic hydrocarbons (toluene, paraxylene), etc.

The composition may contain hydrophobic particles in order to obtain a superhydrophobic coating, such as silicon dioxide particles for example marketed under the trade name “Zeoflo TL”.

The composition may contain other additives, such as silicone, fluorinated and alkyl additives for example, in order to render the material of the external layer 22 hydrophobic.

The composition may contain at least an additive to improve the durability of the anticontaminant properties.

According to one configuration, the isocyanate component is an aliphatic isocyanate prepolymer based on hexamethylene diisocyanate and marketed under the trade name “Desmodur ultra N3300” or “Desmodur ultra N3400”, the polyol component is a perfluorovinylether of FEVE type marketed under the trade name “Lumiflon LF 910LM”, the solvent is butyl acetate and the catalyst is dibutyltin dilaurate, abbreviated to DBTDL.

According to an alternative, the polyol component may be the copolymer marketed under the trade name “Zeffle GK-570”.

The composition may contain hydrophobic particles such as the particles marketed under the trade name ZEOFLO TL for example, a surface additive such as the additive marketed under the trade name BYK-SILCLEAN 3700. If the support is made of metal, the first composition contains an adhesion-promoting additive such as the additive marketed under the trade name BYK 4509 for example.

According to a third example, the material of the external layer 22 is obtained from the following composition containing:
at least a polysilazane component,
at least a solvent.

The composition generally contains at least an additive and at least a catalyst.

According to one configuration, the composition contains:
between 20 and 60 wt % of at least a polysilazane component,
between 40 to 70 wt % of at least a solvent,
between 0 and 2 wt % of at least a catalyst,
between 0 and 15 wt % of at least a hydrophobic additive and/or of hydrophobic particles,
between 0 and 2 wt % of at least a surface additive.

This composition contains between 0.2 and 5% of iron particles to capture the oxygen.

The polysilazane component may be of organic or inorganic type, an inorganic polysilazane component promoting resistance to temperature, an organic polysilazane component promoting the flexibility of the coating. The composition may contain a mixture of several polysilazanes.

According to one configuration, the polysilazane component is polymethyl(hydro)/polydimethylsilazane, such as the component marketed under the trade name “Durazane 1500” or “Durazane 1800”.

The composition may contain hydrophobic particles in order to obtain a superhydrophobic coating, such as silicon dioxide particles for example.

The composition may contain an anticontaminant additive and/or anticontaminant particles such as the compositions of the second family.

By way of example, the catalyst may be dicumyl peroxide. The hydrophobic particles may be the hydrophobic particles marketed under the trade name “Zeoflo TL”. The surface additive may be the product marketed under the trade name “Fluorolink S10”.

According to a fourth example, the material of the external layer 22 is a two-part component obtained by mixing first and second components.

The composition of the first component contains:
at least a silane-terminated polyurethane component having on average at least two alkoxysilane groups per molecule,
a tetraethyl orthosilicate,
at least a solvent;
the composition of the second component contains:
at least a solvent,
the composition of the first component and/or the composition of the second component containing at least an additive and/or at least a catalyst.

This composition contains between 0.2 and 5% of iron particles for capturing the oxygen.

The composition of the first component may contain at least an anticontaminant additive and/or anticontaminant microparticles, at least a hydrophobic additive and/or hydrophobic particles, at least a surface additive.

The composition of the first component may also contain at least an additive, from among silicone, fluorinated and alkyl additives for example, in order to render the material of the external layer 22 hydrophobic, at least an additive aimed at increasing the resistance to heat, at least an additive aimed at improving the adhesion of the coating.

The invention is not restricted to these additives. Others could be added according to the properties desired.

According to another feature, the material of the external layer 22 is selected in such a way as to give the external layer 22 a lubricating effect on the aerodynamic surface S. This lubricating effect is all the more pronounced if the chemical nature of the material of the external layer 22 encourages phase segregation and orientation of the lubricating chains at the aerodynamic surface S.

According to one embodiment, the material of the external layer 22 is obtained from a composition, notably a composition of the fourth family, containing at least a lubricating additive and/or lubricating particles. According to one configuration, the lubricating additive and/or the lubricating particles are present in grafted or non-grafted free form in the composition so as to obtain at the aerodynamic surface S spaced-apart lubricating side chains providing dynamic de-wetting in respect of all liquids. Because the lubricating additive and/or the lubricating particles is/are not connected to the network of the material of the external layer 22, the lubricating film that forms at the aerodynamic surface S becomes sacrificial and allows insect residue 24 to detach under the effect of the air stream 16, without stimulus. Although the lubricant film becomes sacrificial, the self-cleaning effect is sustained in terms of duration by adjusting the concentration of lubricating additive and/or lubricating particles in the composition in order to obtain a sufficiently thick lubricating film at the surface and an action which remains long-lived.

Because the lubricating additive and/or the lubricating particles have a tendency to migrate toward the aerodynamic surface S, the lubricating film progressively regenerates until all the lubricating additives and/or lubricating particles contained in the material of the external layer 22 are exhausted. When the external layer 22 is positioned at an aircraft air intake fitted with a thermal deicing system, the rise in temperature of the external layer 22 during operation of the deicing system encourages the lubricating additives and/or lubricating particles to migrate toward the aerodynamic surface S.

Whatever the composition, the external layer 22, when in the form of a coating 20, is applied by any suitable coating technique, by spraying, by laying a film, etc.

Of course, the invention is not restricted to these compositions for the external layer. Thus, the superhydrophobic materials of the prior art could be used.

Whatever the material used, this material contains at least an oxygen-absorbing additive, preferably iron particles, to extract at least some of the oxygen present in the atmosphere A in sufficient quantity to at least partially deprive of oxygen the hemolymph of the insect residue 24 which hemolymph remains in a liquid or pasty state for longer making it easier for the insect residue 24 to be detached from the aerodynamic surface S by the air stream 16 flowing in contact with the aerodynamic surface S.

According to one configuration, the material of the external layer 22 contains at least an activator configured to give the oxygen-absorbing additive an oxygen-absorbing effect in the widest possible percentage-humidity range.

According to one configuration, the material of the external layer 22 contains silicone filler. In that case, the material of the external layer 22 contains at least 0.2 wt % of silicone. According to one embodiment, the weight content of the silicone is less than or equal to 10% and preferably less than 5%. This silicone filler will naturally have a tendency to migrate toward the surface S and to carry the particles of oxygen-absorbing additive toward this surface S. Upon contact with the air and therefore with the oxygen, the additive will capture the oxygen and in the case of iron, will be converted to iron oxide. Thus, the silicone and the oxygen-absorbing additive will form a film which will limit the capture of oxygen, since the oxygen-absorbing additive will be isolated from the atmosphere by the film. At the moment of an insect strike, this film will detach around the insect residue 24. The oxygen-absorbing additive will once again come into contact with the atmosphere and capture at least some of the oxygen present in the atmosphere A in sufficient quantity to at least partially deprive the hemolymph of the insect residue 24 of oxygen.

According to one configuration, the material of the external layer 22 contains at least a fluorinated compound.

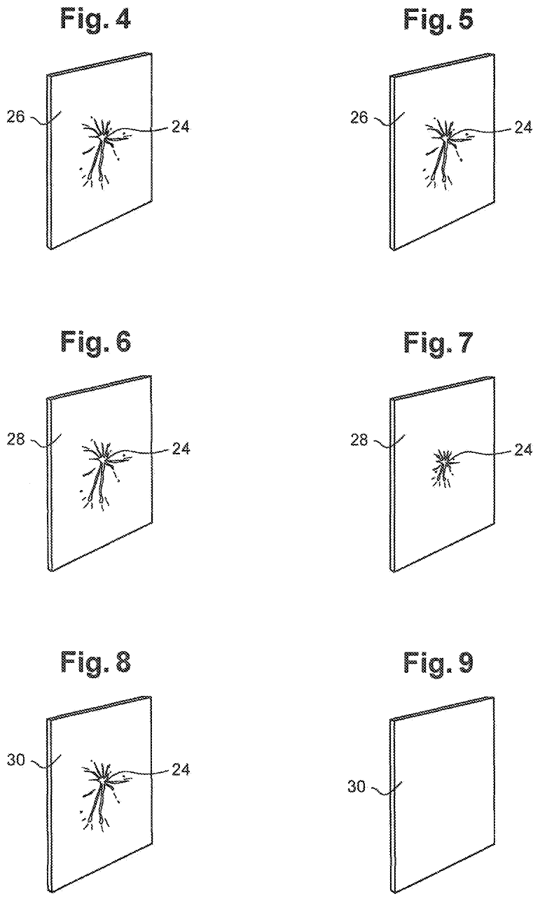

FIGS. 4 to 9 illustrate a test protocol on three different supports. The test protocol consists in blasting an insect against a surface at a velocity of the order of 80 m/s using an insect gun then blowing air from a nozzle for 20 minute in order to clean the surface.

In FIG. 4, the test is performed on a plate 26 made of aluminum alloy, without coating. Just after impact, the plate 26 has insect residue 24 on its surface. After the phase of cleaning by blowing air for a duration of 20 min, the quantity of insect residue 24 is substantially the same as before the cleaning phase, as illustrated in FIG. 5.

In FIG. 6, the test is performed on an aluminum alloy plate 28 having a coating made of a superhydrophobic material. After the phase of cleaning by blowing air for a duration of 20 min, the quantity of insect residue 24 is slightly lower than it was before the cleaning phase, as illustrated in FIG. 7.

In FIG. 8, the test is performed on an aluminum alloy plate 30 having a coating made of an omniphobic material containing iron particles. After the phase of cleaning by blowing with air for a duration of 20 min, the insect residue 24 has practically all disappeared, as illustrated in FIG. 9.

The following TABLE 1 indicates the properties of the surface struck during the three tests and the amount of insect residue after the step of cleaning by blowing with dry air.

TABLE 1

| | | | | | Number | Dimensions |
|---|---|---|---|---|---|---|
| | | Roughness | Wettability | Surface | of water | of residue after |
| | Thickness | Sa | WCA | energy | droplet | dry cleaning phase |
| Coating | (μm) | (μm) | (°) | (mN/m) | impacts | (μm) |
| Al2024 (no | N/A | N/A | 85 | N/A | N/A | 350 |
| coating) | | | | | | |
| Al2024 (with a | 35 | 3.1 | 109 | 17.5 | 1000 to | 130 |
| coating based on | | | | | 3000 | |
| fluorinated | | | | | | |
| polyurethane | | | | | | |
| without additive) | | | | | | |
| Al2024 (with a | 40 | 1.1 | 105 | 21.6 | 6000 | <45 |
| coating based on | | | | | | |
| fluorinated | | | | | | |
| polyurethane with | | | | | | |
| iron-based | | | | | | |
| additive) | | | | | | |

These tests demonstrate the capacity of the external layer 22 to maintain an optimum capacity for self-cleaning by virtue of an air stream.

Thus, the presence of at least an oxygen-absorbing additive in the substance that forms the external layer 22 makes it possible to obtain a self-cleaning coating or to enhance the effectiveness of existing self-cleaning coatings.

Although described in an application to an aircraft, the invention may be implemented on any type of vehicle having at least one aerodynamic surface S over which there flows an air stream that at least temporarily achieves a velocity in excess of 30 m/s.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A self-cleaning external layer comprising:
a surface configured to be in contact with an atmosphere and against which an air stream flows during operation, the surface forming an aerodynamic surface, wherein an external layer of the surface is made from a material containing at least an oxygen-absorbing additive in order to extract at least some oxygen present in the atmosphere in order to at least partially deprive oxygen from a hemolymph of insect residue in contact with said aerodynamic surface following insect strike.

2. The self-cleaning external layer as claimed in claim 1, wherein the oxygen-absorbing additive is iron-based.

3. The self-cleaning external layer as claimed in claim 2, wherein the material of the external layer comprises at least 0.2 wt % of iron particles.

4. The self-cleaning external layer as claimed in claim 3, wherein the material of the external layer comprises less than 10 wt % of iron particles.

5. The self-cleaning external layer as claimed in claim 2, wherein the material of the external layer comprises at least an activator configured to provide the oxygen-absorbing additive an oxygen-absorbing effect over a widest possible percentage-humidity range.

6. The self-cleaning external layer as claimed in claim 5, wherein the activator is an alkali-metal halide or sodium chloride.

7. The self-cleaning external layer as claimed in claim 1, wherein the material of the external layer contains at least 0.2 wt % silicone.

8. The self-cleaning external layer as claimed in claim 7, wherein a weight content of the silicone is less than or equal to 10.

9. The self-cleaning external layer as claimed in claim 1, wherein the external layer is made from a material selected from a group consisting of: superhydrophobic, oleophobic or omniphobic polymers, hydrophilic polymers, polytetrafluoroethylene, fluorinated polyurethane, polysilazane, or SLIPS or sol-gel.

10. The self-cleaning external layer as claimed in claim 1, wherein the material of the external layer comprises at least a fluorinated compound.

11. The self-cleaning external layer as claimed in claim 1, wherein the external layer has a thickness greater than 20 μm.

12. The self-cleaning external layer as claimed in claim 1, wherein the external layer is made from a material having a hardness that encourages the insect residue to bounce off.

13. A vehicle comprising:
the self-cleaning external layer as claimed in claim 1.

14. The vehicle as claimed in claim 13, wherein the vehicle is configured in such a way that an air stream having a velocity in excess of 30 m/s flows against the aerodynamic surface.

15. An aircraft air intake comprising:
the self-cleaning external layer as claimed in claim 1.
